(19) United States
(12) Patent Application Publication
(10) Pub. No.: US 2008/0106053 A1
(43) Pub. Date: May 8, 2008

(54) Handle positioning device for a hand truck

(75) Inventor: Haiming Tsai, Tainan Hsien (TW)

Correspondence Address: Haiming Tsai, P.O. Box 6-9 (717), Tainan, omitted

(73) Assignee: YEE SHIUANN ENTERPRISE CO., LTD

(21) Appl. No.: 11/591,952

(22) Filed: Nov. 3, 2006

(51) Int. Cl. B62B 1/00

(52) U.S. Cl. 280/47.315

(57) ABSTRACT

A handle-positioning device for a hand truck includes two position bases and a pull rod. The position base is respectively fixed on two vertical cross-shaped tubes combined with an inverted U-shaped handle of a hand truck. Each vertical tube has a position hole aligned to that of each position base. The pull rod has some elasticity, and two bent ends, which fit in the position hole of a washer fixed on each pull rod, that of each position base, that of each vertical tube and further in that of the handle to keep the handle at a certain height. The height of the handle is adjusted by handling the pull rod to let the two bent ends to retreat from only the position hole of the handle and then the handle can be moved up and down then positioned again at that adjusted position or height by handling the pull rod.

### BACKGROUND OF THE INVENTION

1. Field of the Invention

This invention relates to a handle-positioning device for a hand truck, particularly to one possible to easily adjust the height of the handle of a hand truck.

2. Description of the Prior Art

There is a U.S. Pat. No. 6,938,905 disclosing a hand truck, which has a handle that is adjusted in its height by the function of three components, plural stop bars 2210, a spring 2211 and two rings. But this structure is too complicated, not convenient to handle.

### SUMMARY OF THE INVENTION

This invention has been devised to offer a handle-positioning device having a simple structure than that of the US patent.

The feature of the invention is two position bases and a pull rod. The position bases are fixed on two cross-shaped vertical tubes combined with two side tubular portions of an inverted U-shaped handle. The pull rod can be pulled to the front side a little to release the handle from the cross-shaped vertical tubes to move up and down, and then when the handle is moved up or down, it can be positioned at a needed height by function of the pull rod elastically letting its two bent ends to fit snappingly and automatically in one of the position holes of two vertical sides of the handle to keep the handle at that position or height newly adjusted.

### BRIEF DESCRIPTION OF DRAWINGS

This invention will be better understood by referring to the accompanying drawings, wherein:

FIG. 1 is an exploded perspective view of a handle-positioning device for a hand truck in the present invention;

FIG. 2 is a perspective view of the handle positioning device for a hand truck in the present invention, showing how to move the handle positioning device for adjusting; and,

FIG. 3 is a partial side cross-sectional view of the handle-positioning device in the present invention.

### DETAILED DESCRIPTION OF THE PREFERRED EMBODIMENT

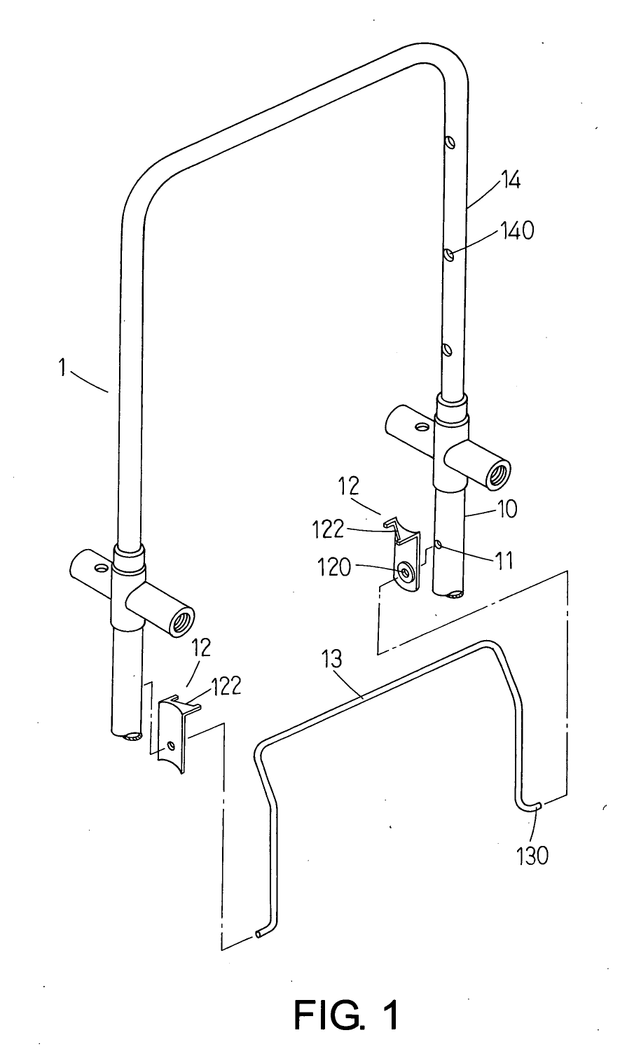

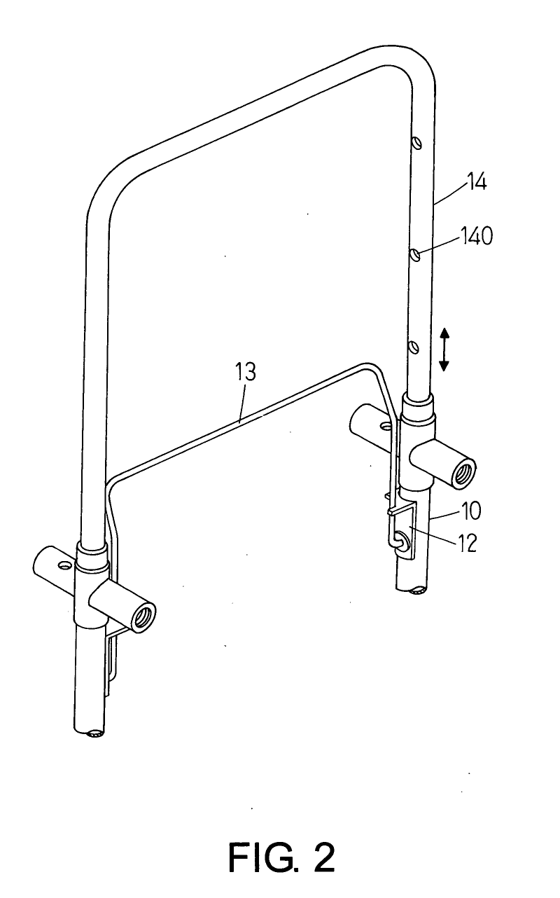

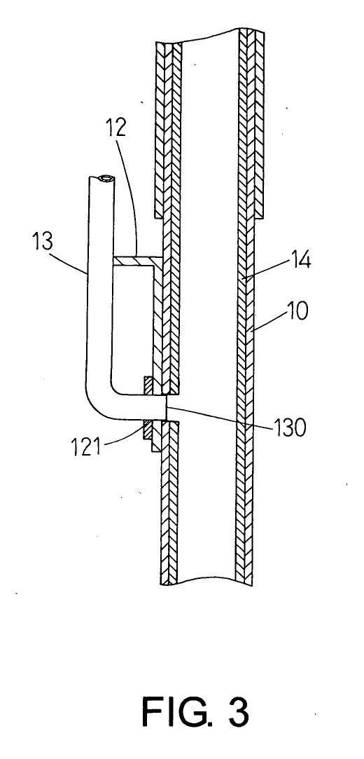

A preferred embodiment of a handle-positioning device for a hand truck in the present invention, as shown in FIGS. 1, 2 and 3, includes two vertical cross-shaped tubes 10, two positioning bases 12, a pull rod 13, and a inverted U-shaped handle 14 as main components combined together.

The vertical cross-shaped tubes 10 are respectively provided with a position hole 11 in an inner lower portion, and a center hole for each side tube of the inverted U-shaped handle 14 to fit in from above.

The position bases 12 are respectively made of a plate with an upper bent horizontal portion and a vertical portion, having a position hole 120 in a lower point in the vertical portion to be aligned to the position hole 11 of the vertical cross-shaped tubes 10, a washer 121 welded on the surface of the position base 12 and having a position hole 1210 aligned to the position hole 11 of the vertical cross-shaped tube 10. The upper horizontal portion of each position base 12 is provided with a recessed outer edge 122 having a front shallow curve and a rear deep curve for two side vertical portions of the inverted U-shaped pull rod 13 to resiliently hook in either of the front shallow curve or the rear deep curve.

The inverted U-shaped pull rod 13 is made of a elastic material, having two side vertical portions, which are formed with a short bent end 130 for fitting in the position hole 1210 of the washer 121, the position hole 120 of the position base 12 and further in one of the position holes 140 of each side vertical portions of the handle 14 to keep the handle 14 at a proper height relative to the vertical cross-shaped tubes 10.

The handle 14 is inverted U-shaped, having two side vertical tubular portions and a plurality of the position holes 140 equidistantly bored in the inner side of each side vertical tubular portion for the bent ends 130 of the pull rod 13 to fit therein to keep the handle 14 stabilized at a height relative to the vertical cross-shaped side tubes 10.

In using, when the handle 14 of the hand truck 1 is adjusted at a certain height, the pull rod 13 is in a position with the two bent ends 130 fitted in the position holes 1210, 220, 11 and 140 (one of selected), keeping the handle 14 immovable in a height relative to the two cross-shaped side tubes 10, with a lower point of the two side vertical portions of the pull rod 13 elastically kept in the rear deep curve of the recess 122 of the upper horizontal portion of each position base 12. If the handle 14 in the height just mentioned is needed to be adjusted in a different height relative to the two cross-shaped tubes 10, the pull rod 13 is gripped with one hand at the intermediate section of the horizontal portion and pulled to the front side a little, letting the two side portions to slide from the rear deep curve to the front shallow curve of the recess 122 of each position base 12 and stopped there by the hand still holding the pull rod 13. Meanwhile the two bent ends 130 of the pull rod 13 may retreat out of the position hole 140 of the two vertical tubular portions of the handle 14 but still stays in the position holes 11 and 120 of the cross-shaped vertical tube the position base. At this time, the vertical tubular portions of the handle 14 are no longer stopped by the two bent ends 130, possible to be pulled up or down depending on the necessity. Then a user pulls the handle 14 up or down to let the two side vertical tubes slide up and down in the cross-shaped vertical tubes 10 to permit one of the position holes 140 to move to align to the position hole 11 of each position base 10. Then the pull rod 130, already released by the hand, may resiliently permit the two bent ends 130 to fit snappingly and automatically in the selected one of the position holes 140 of the handle 14, with the two vertical portions of the pull rod 13 automatically shifting to the rear deep curve of the recess 122 of each position base 12 and stopped there, keeping the handle 14 stabilized at that adjusted position or the height selected relative to the two cross-shaped tubes 10.

The handle-positioning device for a hand truck in the present invention has the following advantages, as can be understood from the foresaid description.

1. The handle-positioning device has a simple structure, with the pull rod in conjunction with the position bases for adjusting the height or position of the handle.

2. The pull rod can take place of the stop bars 2210, the spring 2211 and the two rings 2212 of the US patent mentioned above, lowering the cost of the material and assembly of the device.

3. The handle-positioning device has simple components, very convenient to assemble and repair.

While the preferred embodiment of the invention has been described above, it will be recognized and understood that various modifications may be made therein and the appended claims are intended to cover all such modifications that may fall in the spirit and the scope of the invention.

What is claimed is:

1. A handle adjusting device for a hand truck, said device comprising:
two position bases respectively fixed tightly by welding on an inner side surface of two vertical cross-shaped tubes, each said cross-shaped tube having a position hole in an inner side, each said positioning base made of a plate and having an upper horizontal portion and a lower vertical portion, said lower vertical portion having a position hole bored and aligned to said position hole of each said cross-shaped vertical tube, a washer with a position hole welded on an inner side of each said position base, said position hole of said washer aligned to said position hole of said each position base, said upper horizontal portion provided with a recess in an outer side edge, said recess having a front shallow curve and a rear deep curve;
a pull rod shaped inverted U and made of elastic material and having a horizontal portion and two side vertical portions bending down from two ends of said horizontal portion, each said vertical portion having a bent end extending outward in a nearly right angle for a short length, each said bent end extending in said position hole of said washer, of said position base, of said position hole of each said vertical cross-shaped tube and further in one of plural position holes of each vertical tubular portion of said handle so that said handle may be kept stabilized at a certain height; and,
said pull rod having its intermediate portion kept elastically immovable in said rear deep curve of said recess of said upper horizontal portion of said position bases with said bent ends fitted in one of said position holes of said handle when said handle is kept immovable at a height relative to said two vertical cross-shaped tubes, said pull rod pulled to the front side a little to let the intermediate portion to shift from said rear deep curve to said shallow curved of said recess of said upper horizontal portions so that said bent ends of said pull rod retreat from said position hole of said vertical side tubular portion of said handle, then said bent ends fitting snappingly and automatically in one of said position holes of said handle to position said handle at that position or that height immovable when said handle is moved up or down relative to said vertical cross-shaped tubes and one of said position holes moving to align to said position hole of each said vertical cross-shaped tube.
